(19) United States
(12) Patent Application Publication
(10) Pub. No.: US 2008/0029686 A1
(43) Pub. Date: Feb. 7, 2008

(54) Precision fabricated silicon mold

(75) Inventors: Peter A. Gruber, Mohegan Lake, NY (US); John U. Knickerbocker, Monroe, NY (US)

Correspondence Address: FREDERICK W. GIBB, III;Gibb & Rahman, LLC, 2568-A RIVA ROAD, SUITE 304, ANNAPOLIS, MD, 21401, US

(73) Assignee: International Business Machines Corporation, Armonk, NY (US)

(21) Appl. No.: 11/499,365

(22) Filed: Aug. 4, 2006

(51) Int. Cl. B29C 33/56

(52) U.S. Cl. 249/114.1; 425/810; 425/812

(57) ABSTRACT

The invention provides a reusable precision fabricated silicon mold comprising a mold made of silicon which comprises a desired pattern of physical features cavities etched into the mold to transfer a patter on bumps to a semiconductor wafer, e.g., computer chip, semiconductor device, silicon on insulator device, etc.; an aperture etched into the mold adapted to allow gases to escape but does not to allow a solder to escape during the process of transferring solder bumps to a chip; a protective oxide or nitride on the mold; alignment marks adapted to properly align the mold with a semiconductor wafer; an organic release material on the mold adapted to release the mold from the semiconductor wafer, wherein the mold precisely defines a conductive adhesive material volume for interconnects on the semiconductor wafer.

### BACKGROUND

1. Field of the Invention

The embodiments of the invention generally relate to a mold or form for making interconnects on an electronic device, and, more particularly, to a precision reusable silicon mold/form that minimizes defect density on an electronic device.

2. Description of the Related Art

As electronic devices such as mobile phones, portable digital assistants, and computers get smaller in size, yet have increased functionality, more interconnects on semiconductor devices in order to achieve the increased functionality in these devices become desirable. Present methods for transferring patterns of solder bumps onto to electronic devices (e.g., semiconductor wafers, silicon on insulator wafers, etc.) to provide for interconnects or vias on the device include using molds to transfer the solder (e.g., conductive adhesive) to the semiconductor wafer. The materials used for these molds (i.e., masks) and the tooling techniques available for making this molds limits the size of interconnects that can be transferred.

U.S. Pat. No. 5,775,569, herein incorporated by reference, discloses a mold made of metal or glass to form a pattern of solder bumps on a semiconductor wafer chip.

U.S. Pat. No. 5,219,117, herein incorporated by reference, discloses a process for attaching solder balls to silicon wafers by using preformed solder balls which are deposited on the cavities of a silicon mold. The method utilizes preformed solder balls and not bulk solder and therefore requires additional processing steps for forming the solder balls.

U.S. Pat. No. 5,388,327, herein incorporated by reference, discloses a process for forming a film with holes punctured in it for using as a mold. The holes are filled with a solder paste by a screening process and then the film is heated to melt the solder while the film is applied against a wafer and reflowed. Finally, the film is dissolved by a chemical solvent leaving the solder bumps on the wafer.

### SUMMARY

In view of the foregoing, an embodiment of the invention provides a reusable precision fabricated silicon mold comprising a mold made of silicon which comprises a desired pattern of physical features or cavities etched into the mold to transfer a patter on bumps to a semiconductor wafer (e.g., computer chip, semiconductor device, silicon on insulator device, etc.); an aperture etched into the mold adapted to allow gases to escape but does not to allow a conductive adhesive material (e.g., solder) to escape during the process of transferring solder bumps to a chip; a protective surface on the mold (e.g., oxide, nitride or other protective material); alignment marks adapted to properly align the mold with a semiconductor wafer; an organic release material on the mold adapted to release the mold from the semiconductor wafer, wherein the mold precisely defines a conductive adhesive material volume for interconnects on the semiconductor wafer.

Moreover, the mold of the invention provides for transferring solder bumps having a minimized defect density as compared to other methods using molds made of non-silicon materials such as glass or metal.

These and other aspects of the embodiments of the invention will be better appreciated and understood when considered in conjunction with the following description and the accompanying drawings. It should be understood, however, that the following descriptions, while indicating preferred embodiments of the invention and numerous specific details-thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIGS. 1A and 1B illustrate schematic diagrams of the mold of the invention and the mold having left a desired patter of solder bump on a semiconductor device.

FIG. 2 is a flow diagram illustrating a preferred method of an embodiment of the invention.

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned, there remains a need for decreased interconnect size to allow for higher interconnect density on a chip as well as a minimized defect density of the interconnects on a semiconductor chip. The embodiments of the invention achieve this by providing a precision fabricated silicon mold wherein the mold precisely defines the physical features of the solder bumps and precisely defines the solder volume of the interconnections on the silicon wafer.

Precision fabricated Silicon mold can be used to precisely define solder volume for use as solder interconnections such as small solder bumps or C-4, use to fabricate and transfer edge seal or ring, form and transfer multiple size bumps, create bumps with option to assist in release of bumps from mold. Mold can have RIE or alternate method of shaped features for formation of solder, oxide, nitride or silicon as forming shape. Mold holes can also be rectangular shape to form edge seal using solder. Mold is CTE matched to Silicon for excellent transfer positional accuracy even for large wafers such as 200 mm and 300 mm. Mold can also have option for very small through holes which permit gas to escape but not allow solder to enter which can permit void free solder and act to use forced gas to help remove bumps, solder columns or edge seal material from mold. Shapes may be precision controlled for depth, width and thus volume control of the solder. Mold is reusable and can work with IMS solder for many solder compositions. Oxide and/or nitride surfaces can be used to enhance mold life. Support controlled co planarity of bumps even at different size based on use of width and depth of solder and precision control of adjoining Ball Limiting Metal Pads. Through Silicon etched alignment marks can be used to align Si precision mask to wafer for solder transfer.

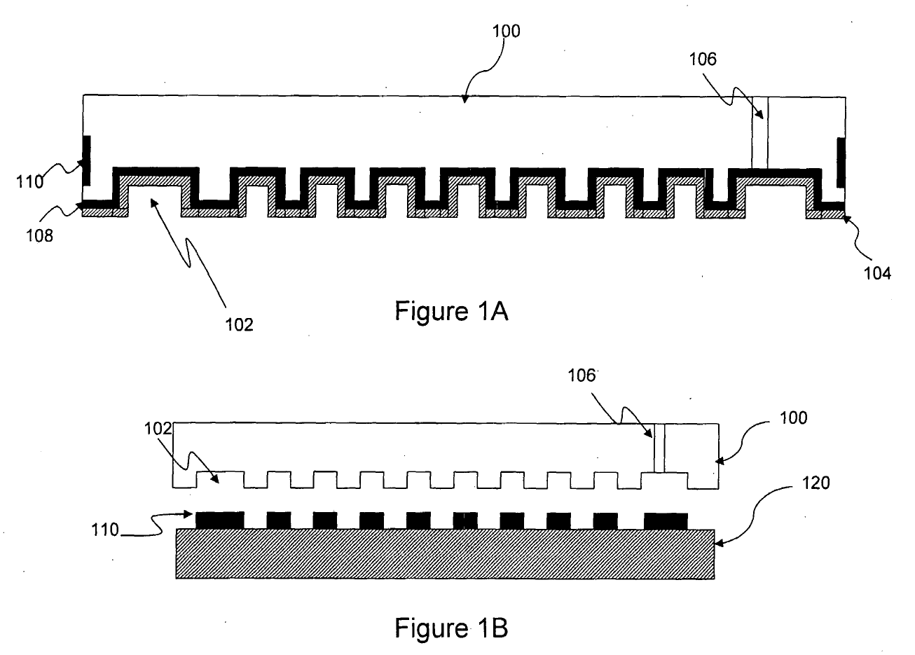

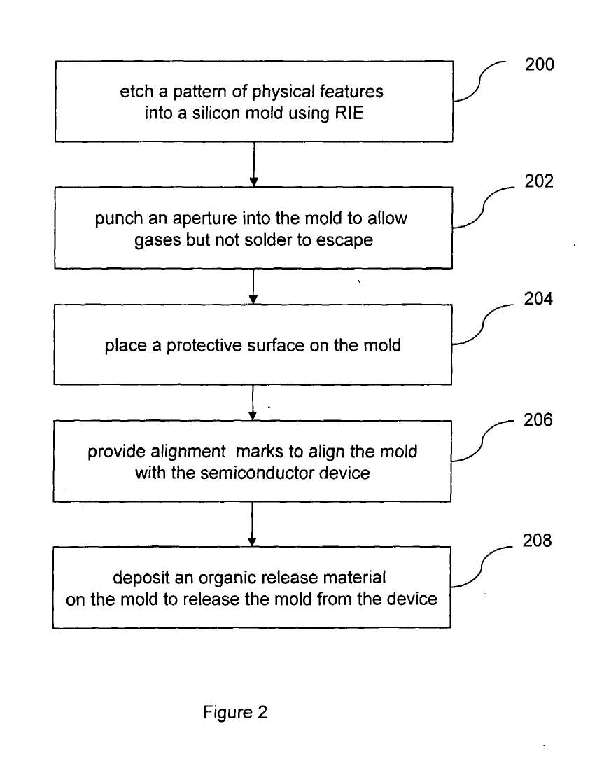

Referring now to the drawings, and more particularly to FIGS. 1A through 2, where similar reference characters denote corresponding features consistently throughout the figures, there are shown preferred embodiments of the invention.

FIG. 1A is drawn to a schematic representation of the reusable precision fabricated silicon mold (i.e., mask) comprising a mold made of silicon (100) comprising a desired pattern of physical features (102) etched into the mold; an aperture (106) etched into the mold adapted to allow gases to escape but does not allow a conductive adhesive material (e.g., solder) to escape; a protective surface on the mold selected from the group of: an oxide and a nitride (108); and an release material (104) on the mold adapted to release the mold from the semiconductor wafer, wherein the mold precisely defines a solder volume for interconnects bumps, edges, edge seals, rings, columns, and various combinations of shapes, and combinations of sizes. The release material provides for ease of mold release may be an organic which can be deposited by vapor or liquid deposition for later release using thermal Tg release or decomposition. Other alternate materials to enhance release as are known to those of skill in the art may be used as well. FIG. 1A also depicts alignment marks (110) on the mold for alignment with marks in or through the wafer or aligned with a notch at the edge of wafer for reference and proper positioning.

FIG. 1B shows a simplified schematic of the reusable precision fabricated mold of the invention. This schematic does not specifically show the protective surface (104) or the release material (104), but of skill in the art would understand that these materials may be present. FIG. 1B shows a pattern of solder bump, i.e. conductive adhesive material, on the surface of a semiconductor wafer (120) that reflects the pattern of physical features found in the silicon mold of the invention.

FIG. 2 is a flow diagram of a method of making the reusable precision fabricated silicon mold of the invention comprising: etching a desired pattern of physical features etched into a mold made of silicon using reactive ion etching (200); punching an aperture into the mold wherein the aperture allows gases to escape but does not allow solder to escape (202); placing a protective surface on the mold selected from the group of: an oxide and a nitride to provide protection for the mold and make it reusable (204); providing alignment marks adapted to align the mold in contact with a semiconductor wafer (206); and depositing an release material on the mold to release the mold from the semiconductor wafer (208), wherein the solder mold precisely defines solder volume for solder interconnections on the wafer.

More particularly, the silicon precision mold of the invention herein described may be used in place of IMS glass etched solder masks for forming solder bumps on a silicon wafer. As described above for FIG. 2 the silicon solder mold or mask is formed by etching and oxidizing the surface of a work piece made of silicon mold using etching and oxidation processes such as reactive ion etching (RIE) and thermal oxidation, for example. Etching and refilling the cavities made by the etching process precisely controls the depth of the features of the mold and, thus, the solder volume that may be accommodated by the mold formed in this process. Thus, a desired pattern of vias and trenches for later solder fill having a controlled diameter, depth and shape are formed.

Moreover, the present method of making the silicon mold of the invention allows the shape of the physical features of the invention to be particularly tailored if desired wherein a tapered structure or very small are desired for example. In another embodiment alignment marked are place on the mold for alignment with reference or alignment marks on the silicon wafer or alignment with notches at the edge of the wafer for proper placement of the mold and proper deposition of the solder. It also may be desirable to one of skill in the art to use a thermal oxide or a nitride surface to enhance robustness of mold, wettability characteristics, adjust the size of the mold, etc.

In another embodiment, the mold of the invention can be used as is or mounted with adhesive to backing plate, glass or notched glass if planning vacuum or pressure release of the mold from the silicon wafer.

In another embodiment of the invention using the mold of the present invention, the features, i.e., cavities, made by the process described herein, are filled with solder of desired composition using IMS tool with molten solder to flow and fill etched cavities. The solder is then transferred from the precision solder mold to a silicon wafer such that bumps, edge seal, columns or combination of shapes, sizes, and compositions of solder, alloy or multiple compositions at same time.

In yet another embodiment, the cavities or openings in the mold may be filled with solder by IMS solder injection with a desired solder composition. The silicon mold of the invention comprising matching solder connections to the desired silicon wafer is aligned with the silicon wafer, and the mold and the wafer are held together for solder reflow/transfer. A mechanical apparatus or pressure may be used to ensure that molds are held to ensure that molds are held together for solder transfer, as is known to those in the art. Solder transfer may be enhanced with use of pressure through mold, use of mold release, etc. Additionally, more than one solder may be transferred, if desired, by use of the mold of the invention mold with previously filled multiple solders, or alternatively, by multiple transfers of solder which can support hierarchy of solder use temperatures. Moreover, larger cavity may be used if processing sequentially over existing solder connections.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A reusable precision fabricated silicon mold comprising:
a silicon mold adapted to maintain a conductive material and comprising a desired pattern of physical features etched into said mold;
an aperture in said mold adapted to allow gases to escape from said mold but does not allow said conductive adhesive material to escape from said method;
a protective surface on said mold comprising one of: an oxide and a nitride;
alignment marks on said mold adapted to align said mold with a semiconductor wafer; and
a release material on said mold adapted to release said mold from said semiconductor wafer,
wherein a size and shape of said mold precisely defines a conductive adhesive material volume for interconnects on said semiconductor wafer, and
wherein said mold is adapted to transfer said conductive adhesive to said semiconductor wafer comprising previously filled multiple solders.

2. The reusable precision fabricated silicon mold of claim 1, wherein said desired pattern of physical features are selected from the group consisting of: bumps, edges, edge seals, rings, columns, combinations of shapes, and combinations of sizes.

3. The reusable precision fabricated silicon mold of claim 1, wherein said mold is adapted to sequentially transfer said conductive adhesive having a hierarchy of temperatures by multiple transfers of solder.

4. A reusable precision fabricated silicon mold comprising:
a silicon mold adapted to maintain a conductive material and comprising a desired pattern of physical features etched into said mold, wherein said desired pattern of physical features are selected from the group consisting of: bumps edges, edge seals, rings, columns, combinations of shapes, and combinations of sizes.
an aperture in said mold adapted to allow gases to escape from said mold but does not allow said conductive adhesive material to escape from said method;
a protective surface on said mold comprising one of: an oxide and a nitride;
alignment marks on said mold adapted to align said mold with a semiconductor wafer;
at least one cavity on said mold larger than at least one preexisting solder connection on said semiconductor wafer, said cavity adapted to sequential processing over said preexisting solder connections; and
a release material on said mold adapted to release said mold from said semiconductor wafer,
wherein a size and shape of said mold precisely defines a conductive adhesive material volume for interconnects on said semiconductor wafer,
wherein said mold is adapted to transfer said conductive adhesive to said semiconductor wafer comprising previously filled multiple solders, and
wherein said mold is adapted to sequentially transfer said conductive adhesive having a hierarchy of temperatures by multiple transfers of solder.

5. The reusable precision fabricated silicon mold of claim 4, wherein said release material adapted to release said mold from said silicon wafer after multiple transfers of said conductive adhesive and any temperature of said conductive adhesive.

6. The reusable precision fabricated silicon mold of claim 4, wherein said mold is adapted to sequentially transfer said conductive adhesive having a hierarchy of temperatures by multiple transfers of solder.
